(19) United States
(12) Patent Application Publication
(10) Pub. No.: US 2013/0107059 A1
(43) Pub. Date: May 2, 2013

(54) NOISE DETECTING DEVICE, NOISE DETECTING METHOD, AND PROGRAM

(71) Applicant: Sony Corporation, Tokyo (JP)

(72) Inventors: Hiroyasu Baba, Kanagawa (JP); Naoki Komine, Saitama (JP)

(73) Assignee: SONY CORPORATION, Tokyo (JP)

(21) Appl. No.: 13/658,557

(22) Filed: Oct. 23, 2012

(30) Foreign Application Priority Data
Oct. 28, 2011 (JP) 2011-237743

(51) Int. Cl. H04N 17/00

(52) U.S. Cl. 348/188; 348/E17.002

(57) ABSTRACT

A noise detecting device includes an image acquiring unit and a parallel processing unit. The image acquiring unit acquires an image from a camera that captures the image of a test pattern including a plurality of lines tilted at a specific angle relative to a specific direction. The parallel processing unit sequentially extracts image signals for two lines extending in parallel in the specific direction of the image, the two parallel lines being away from each other by a specific number of lines, and performs in a parallel manner, for each image signals for the two parallel lines, processing for detecting noise generated in the image on the basis of a difference in pixel values calculated from the image signals for the two parallel lines.

### CROSS REFERENCES TO RELATED APPLICATIONS

The present application claims priority to Japanese Priority Patent Application JP 2011-237743 filed in the Japan Patent Office on Oct. 28, 2011, the entire content of which is hereby incorporated by reference.

### BACKGROUND

The present disclosure relates to a noise detecting device, a noise detecting method, and a program that detect, for example, noise superimposed on moving images captured with a camera as a test object.

Due to the development of manufacturing technology of cameras, it has become possible to easily capture moving images. Cameras often capture images of natural materials. Images of natural materials contain various components such as, for example, frequency components. In the explanation given below, scenes photographed with cameras will be referred to as “natural scenes”.

FIG. 13 illustrates an example of an image of a natural scene captured with a camera.

The image illustrated in FIG. 13 contains buildings and the sky. The image includes a “gradation region” representing changes in the color tone of the sky and a “same-color region” representing a certain area having the same color. The image also includes a “high-frequency region” representing a repetitive pattern, such as a fine pattern or the like, and an “edge region” corresponding to corners of buildings and the like and representing a portion exhibiting a high contrast ratio.

In order to capture the image of the natural scene illustrated in FIG. 13 as a natural moving image, various performance tests are performed on cameras.

FIG. 14 illustrates an example of the configuration of an imaging test system 100 of related art that performs a test for noise superimposed on moving images.

The imaging test system 100 includes a natural scene 101, a camera 102 that captures an image of the natural scene 101 as a moving image and for which a test as to whether noise is superimposed on the moving image is performed, and a test monitor 103 that displays the moving image output from the camera 102. The case where the camera 102 is used as a test object so that the imaging performance of the camera 102 is tested is illustrated as the example of FIG. 14. The camera 102 is irradiated with strong radio waves on the assumption of various disturbances, and the output level of the power source voltage to be supplied to the camera 102 is changed. A tester 104 visually observes the moving image displayed on the test monitor 103 to determine whether or not noise (for example, block noise, a beat by which an image is deviated in a horizontal direction, etc.) is superimposed on the moving image.

For example, a technology disclosed in Japanese Unexamined Patent Application Publication No. 2006-325122 is available as a technology to be used for estimation of noise superimposed on moving images. In the technology disclosed in Japanese Unexamined Patent Application Publication No. 2006-325122, a test image is scrolled through, a sample image that is similar to the test image is specified, and the index value of the sample image is defined as the index value of the test image.

### SUMMARY

In the case of visual observation tests carried out by a plurality of testers 104, the skills of determining whether or not noise is generated vary from individual to individual. Furthermore, since the tester 104 stays in front of the test monitor 103 for a long time for a test that relies on human operation, the concentration of the tester 104 may not last long, thus causing false test results.

In addition, in the case of a moving image obtained by capturing an image of a natural scene, even when a test is automated, it is difficult to determine whether a portion determined by the tester 104 to be noise is actual noise or a pattern existing in the natural scene. Furthermore, even with the technology disclosed in Japanese Unexamined Patent Application Publication No. 2006-325122, the level of the skill of comparing a sample image with a test image differs depending on the ability of the tester 104. Thus, a plurality of testers 104 may produce different test results. In addition, in the case where a moving image used as a reference for a noise test is stored in a memory, since a large memory capacity is used for such a moving image, a limited amount of memory capacity allocated to a noise detecting device is not efficiently used. Furthermore, in order to achieve synchronization between a reference moving image and a moving image to be tested, a new mechanism for achieving synchronization timing is used, thus taking more time, effort, and money.

It is desirable to efficiently perform a test for noise superimposed on a moving image.

According to an embodiment of the present disclosure, an image is acquired from a camera that captures the image of a test pattern including a plurality of lines tilted at a specific angle relative to a specific direction.

Image signals for two lines extending in parallel in the specific direction of the image, the two parallel lines being away from each other by a specific number of lines, are sequentially extracted, and processing for detecting noise generated in the image is performed in a parallel manner, for each image signals for the two parallel lines, on the basis of the difference in pixel values calculated from the image signals for the two parallel lines.

Accordingly, with the use of a difference in image signals for two lines extending in parallel in the specific direction, processing for detecting noise generated in an image can be performed automatically.

According to an embodiment of the present disclosure, an image acquired from a camera includes a test pattern including a plurality of lines tilted at a specific angle relative to a specific direction. Image signals for two lines extending in parallel in the specific direction of the image are extracted, and a portion where a difference in pixel values is generated is determined to be a position where noise is generated. Thus, noise determination can be automatically achieved, irrespective of the skill of a tester.

Additional features and advantages are described herein, and will be apparent from the following Detailed Description and the figures.

### BRIEF DESCRIPTION OF THE FIGURES

FIG. 1 is a perspective view illustrating an example of the external configuration of a moving image noise detecting system according to an embodiment of the present disclosure;

FIG. 2 is a block diagram illustrating an example of the internal configuration of a moving image noise detecting device according to an embodiment of the present disclosure;

FIG. 3 is an explanatory diagram illustrating an example of the conceptual configuration of a test pattern used in an embodiment of the present disclosure;

FIG. 4 is an explanatory diagram illustrating an example of a specific configuration of a test pattern used in an embodiment of the present disclosure;

FIG. 5 is an explanatory diagram illustrating an example of the operation of a test pattern used in an embodiment of the present disclosure;

FIG. 6 is an explanatory diagram illustrating an example of a moving image of a test pattern for one frame in an embodiment of the present disclosure;

FIG. 7 is an explanatory diagram illustrating an example of a reference line and a test line in the case where a specific test pattern is used in an embodiment of the present disclosure;

FIGS. 8A and 8B are explanatory diagrams of the patterns of pixel values of a reference line and a test line, respectively, in an embodiment of the present disclosure;

FIGS. 9A and 9B are explanatory diagrams illustrating examples of the patterns of pixel values of a reference line and a test line, respectively, in an embodiment of the present disclosure;

FIGS. 10A and 10B are explanatory diagrams illustrating examples of the patterns of pixel values in the case where noise is superimposed on a reference line in an embodiment of the present disclosure;

FIG. 11 is an explanatory diagram illustrating an example in which differences in the pixel values of a reference line and a test line that are made to match one another in the vertical direction are plotted in an embodiment of the present disclosure;

FIGS. 12A and 12B are explanatory diagrams illustrating an image in which noise is superimposed and an example in which a detection result of the noise is illustrated, respectively, in an embodiment of the present disclosure;

FIG. 13 is an explanatory diagram illustrating an example of an image of a natural scene captured with a camera; and

FIG. 14 illustrates the external configuration of an imaging test system of related art that performs a test for noise superimposed on a moving image.

### DETAILED DESCRIPTION

Hereinafter, embodiments of the present disclosure will be described. The description will be given in the following order:

1. Embodiment (noise detection: example of processing for determining whether noise is generated on the basis of two horizontal lines)

2. Modifications

### 1. Embodiment (Example of Processing for Determining Whether Noise is Generated on the Basis of Two Horizontal Lines)

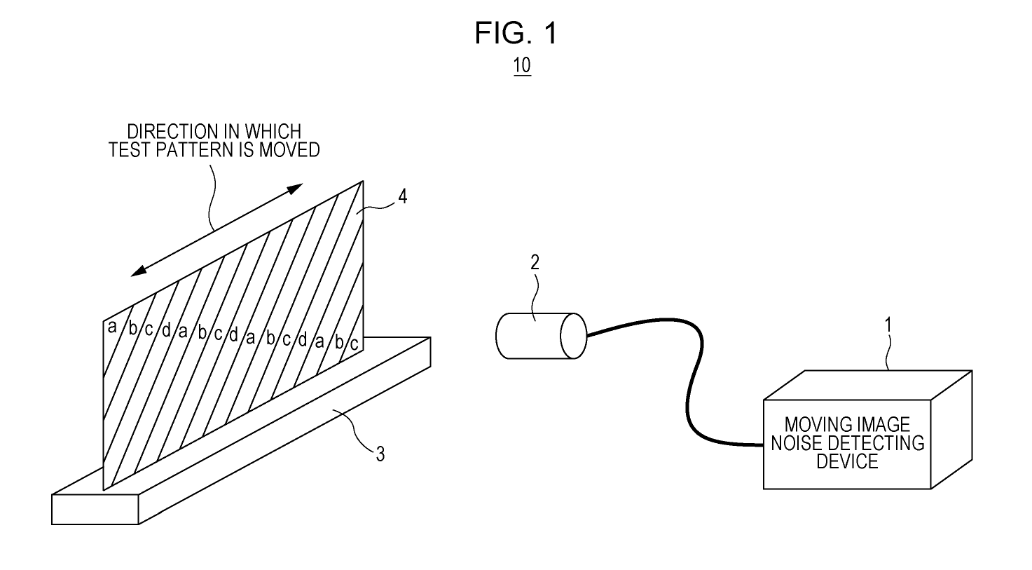

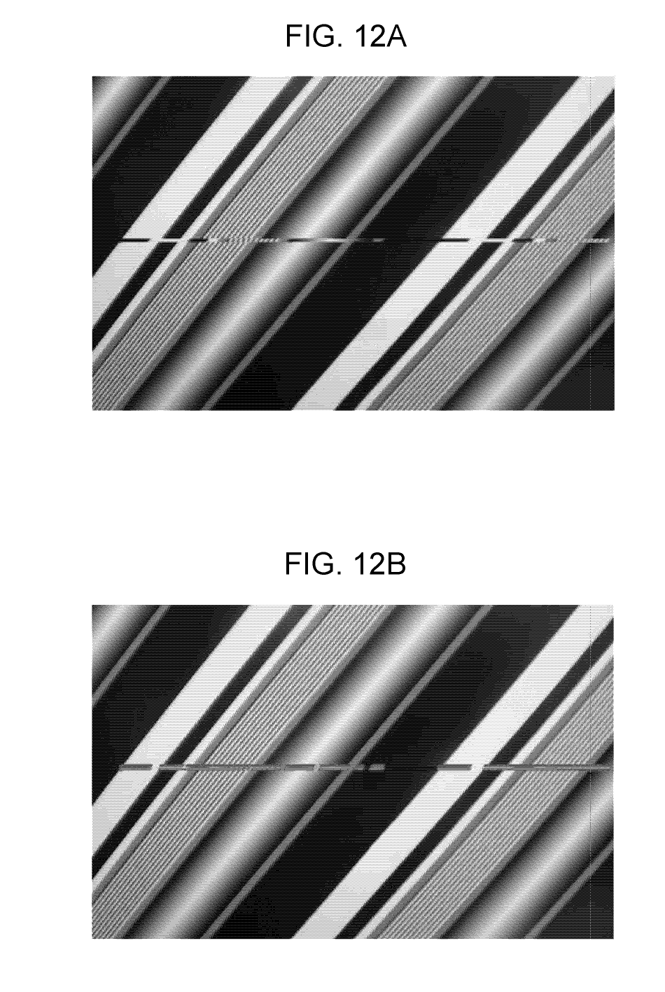

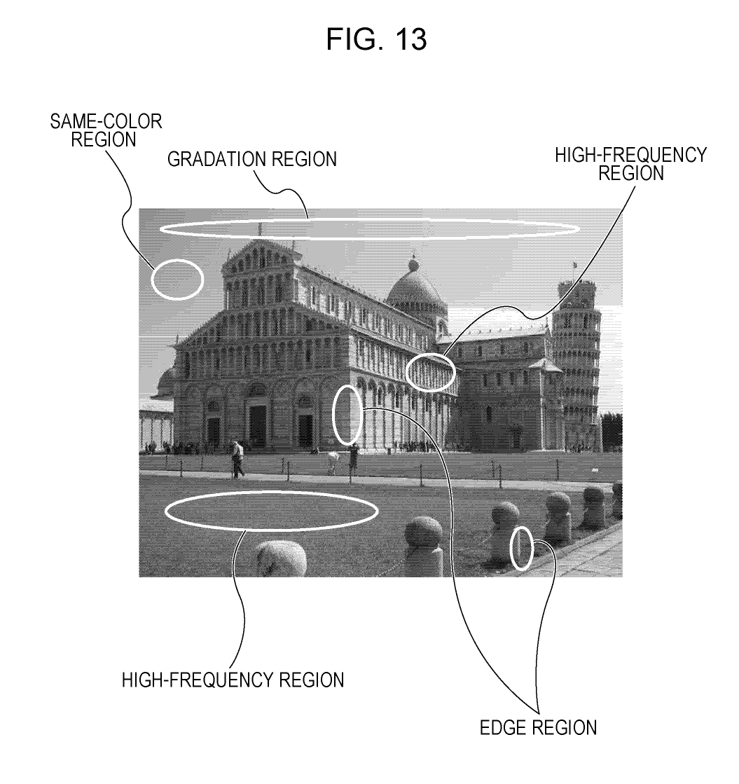

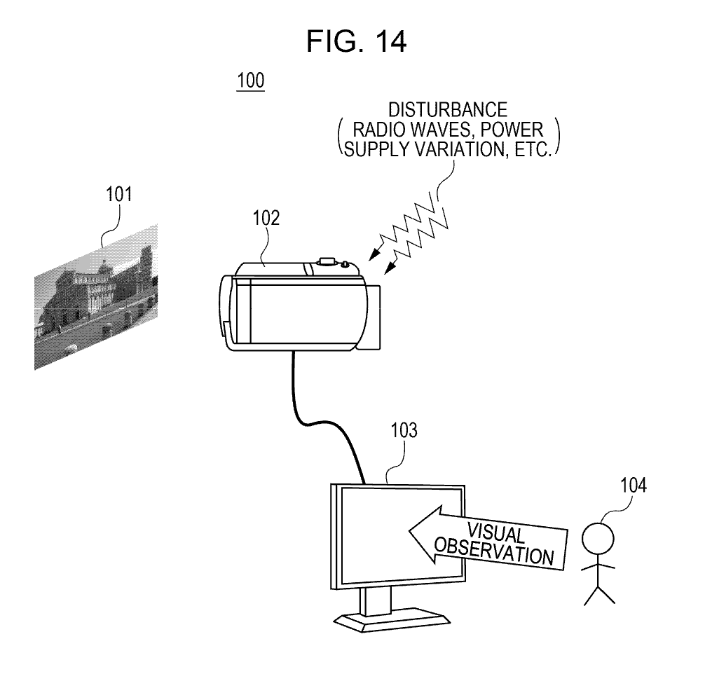

Hereinafter, an embodiment of the present disclosure (hereinafter, referred to as “this embodiment”) will be explained with reference to FIGS. 1 to 12B. In this embodiment, an example will be explained in which this embodiment is applied to a moving image noise detecting device 1 that employs a moving image noise detecting method for automatically detecting noise superimposed on a moving image captured with a camera. First, an example of the configuration of the moving image noise detecting device 1 will be explained.

FIG. 1 illustrates an example of the external configuration of a moving image noise detecting system 10 according to this embodiment.

The moving image noise detecting system 10 includes the moving image noise detecting device 1 that detects noise superimposed on a moving image. The moving image noise detecting system 10 also includes a test object 2 that is connected to the moving image noise detecting device 1 and for which a test is performed for noise superimposed on a captured and output moving image. The moving image noise detecting system 10 also includes a plate-like test panel 4 on which a test pattern is printed. In this embodiment, a video camera that is capable of capturing moving images is used as the test object 2.

The test pattern printed on the test panel 4 is a striped pattern including a plurality of lines that are tilted at a specific angle relative to a specific direction, as described below. The test panel 4 is relatively moved in a horizontal direction at a uniform velocity by a pattern operation unit 3. In this embodiment, “a horizontal direction” is defined as the specific direction, and “an angle of 45 degrees in the upper right direction relative to the horizontal direction” is defined as the specific angle of the test pattern. The test object 2 captures an image of the moving test pattern, and the moving image noise detecting device 1 performs processing for detecting noise from the image captured with the test object 2, so that the performance of the test object 2 can be estimated. The moving image noise detecting device 1 and the pattern operation unit 3 may be connected to each other so that the moving velocity and position of the pattern operation unit 3 can be changed in accordance with an instruction from the moving image noise detecting device 1.

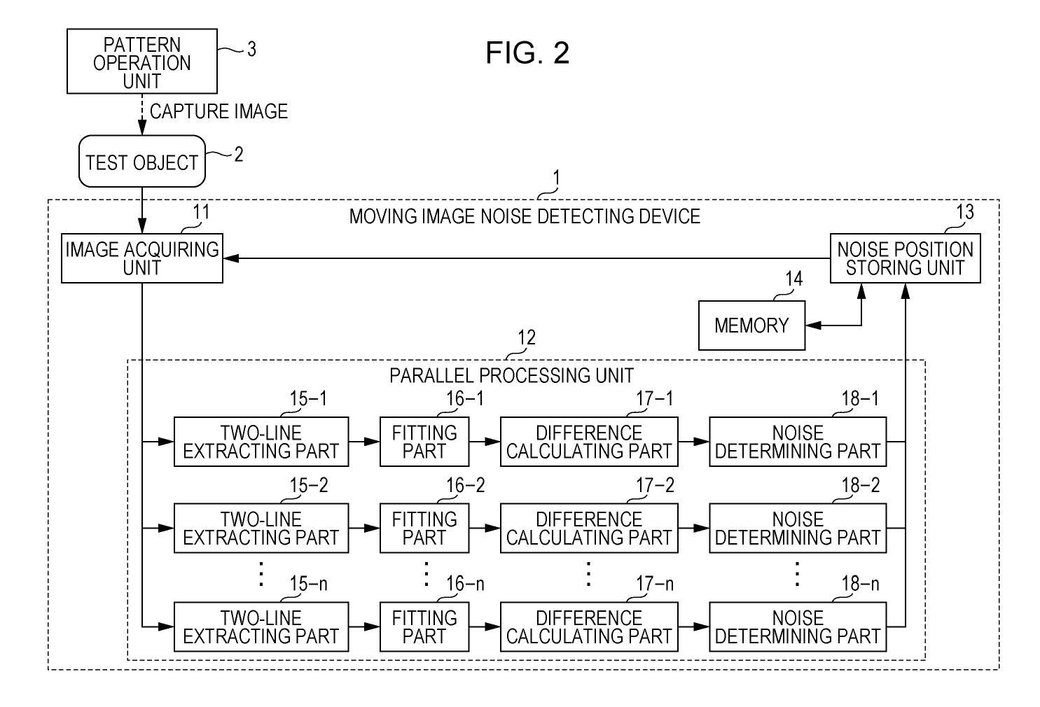

FIG. 2 illustrates an example of the internal configuration of the moving image noise detecting device 1.

The moving image noise detecting device 1 includes an image acquiring unit 11 that acquires a moving image obtained by capturing an image of the test pattern from the test object 2 serving as a test object. The moving image noise detecting device 1 also includes a parallel processing unit 12 that performs specific processing in a parallel manner for each two lines extracted from the moving image. The moving image noise detecting device 1 also includes a noise position storing unit 13 that stores the position of noise in the moving image determined by the parallel processing unit 12 into a memory 14. The memory 14 may be, for example, a rewritable random access memory (RAM).

The parallel processing unit 12 performs processing for extracting image signals for two horizontal lines extending in parallel in the horizontal scanning direction of a moving image, the two parallel horizontal lines being away from each other by a specific number of lines, and detecting, for each image signals for the two parallel horizontal lines in a parallel manner, noise generated in the moving image on the basis of a difference in pixel values obtained from the image signals for the two parallel horizontal lines.

The parallel processing unit 12 includes a two-line extracting part 15-1 that extracts image signals for two horizontal lines, which are away from each other by a specific number of lines (Δn lines), from a moving image for one frame acquired by the image acquiring unit 11. One of the two horizontal lines is defined as a reference line and the other horizontal line is defined as a test line.

The parallel processing unit 12 also includes a fitting part 16-1 that calculates the amount of shift in the horizontal direction of the pattern of individual pixel values on the basis of a specific angle of the tilt of the test pattern relative to the horizontal direction and the number of lines between the reference line and the test line. The fitting part 16-1 calculates, as the amount of shift in the horizontal direction, the minimum sum of squares of the difference between the pixel values of the reference line and the test line.

The parallel processing unit 12 also includes a difference calculating part 17-1 that calculates the difference in the pixel values of the reference line and the test line by making the patterns of the individual pixel values match one another on the basis of the calculated amount of shift in the horizontal direction. The parallel processing unit 12 also includes a noise determining part 18-1 that determines that noise is not generated when the difference does not exceed a threshold and determines that noise is generated when the difference exceeds the threshold over a certain range.

As described above, the two-line extracting part 15-1 to the noise determining part 18-1 determine whether noise is generated in image signals for two lines that are away from each other by Δn lines. In order to determine whether noise is generated in image signals for the other lines, a number (n) of parallel processing operations corresponding to half the number of vertical lines of the imaging area of the test object 2 are performed. Thus, although all the processing parts are not illustrated, a plurality of sets of two-line extracting parts 15-1 to 15-n, fitting parts 16-1 to 16-n, difference calculating parts 17-1 to 17-n, and noise determining parts 18-1 to 18-n that are arranged in parallel detect noise in a parallel manner. A pair of reference line and test line that are extracted by a two-line extracting part is not the same as a pair of reference line and test line that are extracted by a different two-line extracting part. For example, in the case where the number of horizontal pixels of the imaging area of the test object 2 is 1920 and the number of vertical lines of the imaging area of the test object 2 is 1080, n represents 540 (=1080/2).

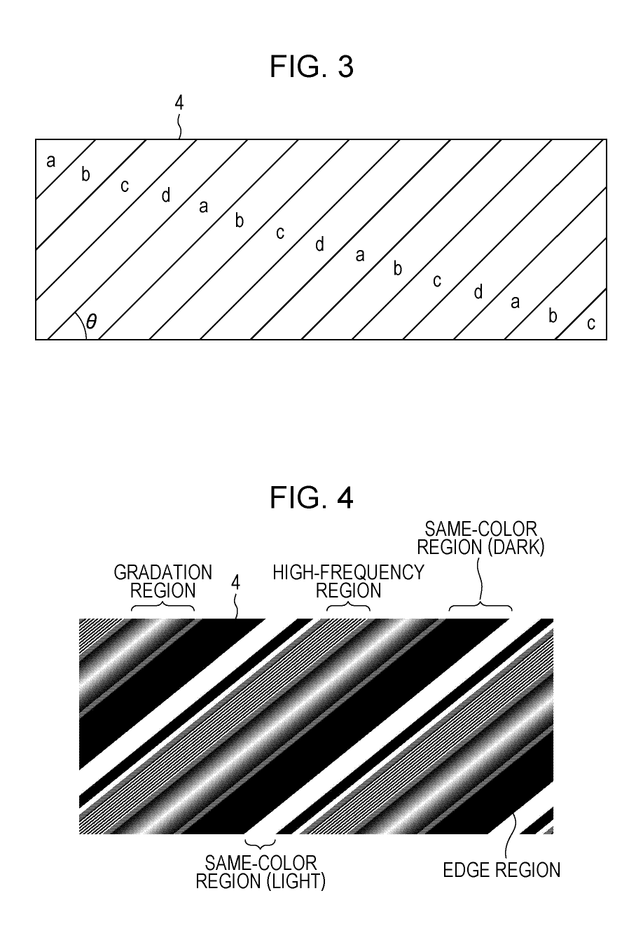

An example of the configuration of a test pattern will now be explained with reference to FIGS. 3 and 4.

FIG. 3 illustrates an example of the conceptual configuration of a test pattern.

The test pattern is a periodic pattern that expresses characteristics existing in a natural scene, such as a high-frequency region a, a gradation region b, a same-color region (dark) c, a same-color region (light) d, and the like, using a plurality of consecutive lines.

As described above, the test pattern has stripes including a plurality of oblique lines that are tilted at, as a specific angle, an angle of 45 degrees, in the upper right direction. With the use of this test pattern, the same processing can be applied to any horizontal scanning period in a moving image captured with the test object 2. This test pattern is suitable for increasing the speed of a noise test. Furthermore, with the oblique lines, when the test pattern is moved only in the horizontal direction, images can be captured as if the stripes were moved in horizontal and vertical directions.

FIG. 4 illustrates an example of a specific configuration of the test pattern.

The test pattern used in this embodiment has stripes of black and white. By changing the color depth of the stripes, unifying the color, or making the widths of the stripes narrower, the stripes simulate various components appearing in a natural scene.

For example, in the gradation region, the brightness continuously changes between black and white. The high-frequency region has a plurality of oblique lines that are narrower than the others. The dark same-color region has one wide black oblique line, and the light same-color region has one wide white oblique line. A portion where the dark same-color region and the light same-color region are adjacent to each other is defined as an edge region exhibiting a high contrast ratio.

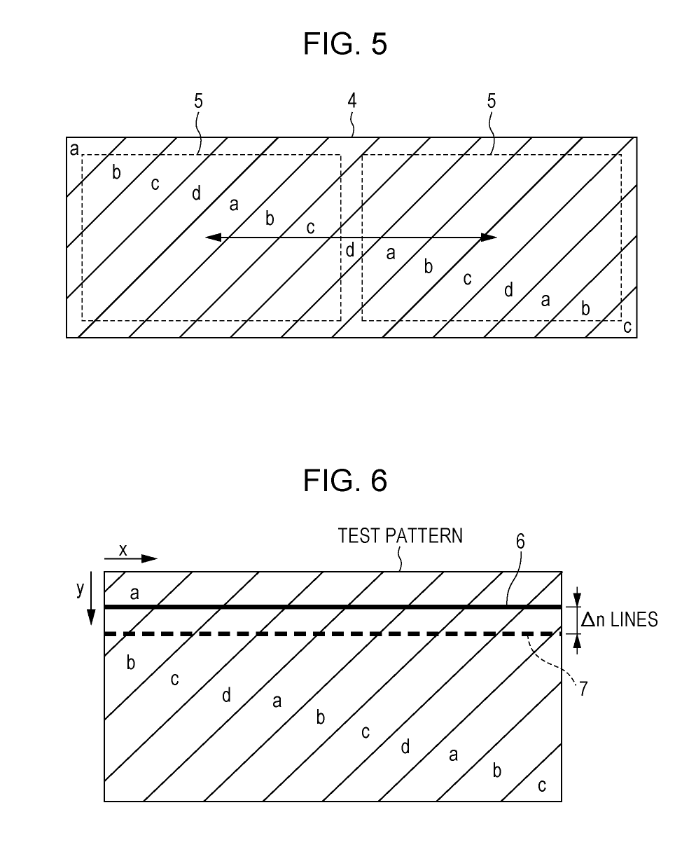

An example of the operation of the test pattern will now be explained with reference to FIGS. 5 to 11.

FIG. 5 illustrates an example of the operation of the test pattern.

The test pattern is moved in the horizontal direction by the pattern operation unit 3. The pattern operation unit 3 moves the test panel 4 at a constant velocity in such a manner that an imaging area 5 of the test object 2 is located inside the test pattern. The pattern operation unit 3 may move the test panel 4 with a variable movement in a sinusoidal wave manner, in which the test panel 4 is moved slowly at first, then the movement speed gradually increases, and the test panel 4 is gradually stopped at the end. A moving image for one frame of the test pattern captured with the test object 2 is acquired by the image acquiring unit 11.

FIG. 6 illustrates an example of a moving image of the test pattern for one frame.

The two-line extracting part 15-1 performs horizontal scanning of a moving image acquired by the image acquiring unit 11 and obtains a reference line 6 and a test line 7. A horizontal line that is away from the reference line 6, which is represented by a solid line in the moving image for one frame, by Δn lines is defined as the test line 7. The two lines extracted at this time, that is, the reference line 6 and the test line 7, are extracted in such a manner that all the lines in the image for one frame are classified into either the reference line 6 or the test line 7. For example, the two-line extracting parts 15-1 to 15-n extract all the odd-numbered horizontal lines as the reference lines 6 and extract all the even-numbered horizontal lines as the test lines 7. Accordingly, all the odd-numbered lines included in an image for one frame are defined as the reference lines 6.

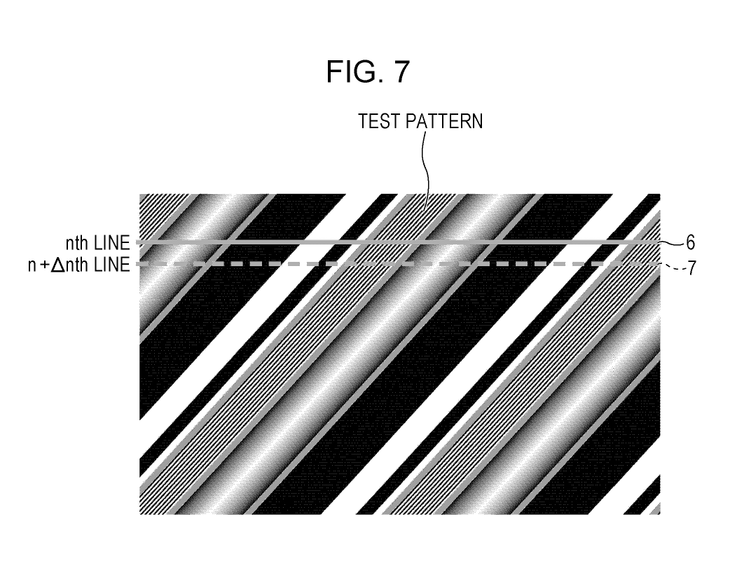

FIG. 7 illustrates an example of the reference line 6 and the test line 7 in the case where a specific test pattern is used.

The two-line extracting parts 15-1 to 15-n extract the reference lines 6 and the test lines 7 from the test pattern including the various regions described above. Thus, the individual lines have dark portions and light portions. It is assumed that a graph representing the pixel values of each horizontal line exhibits a constant pattern.

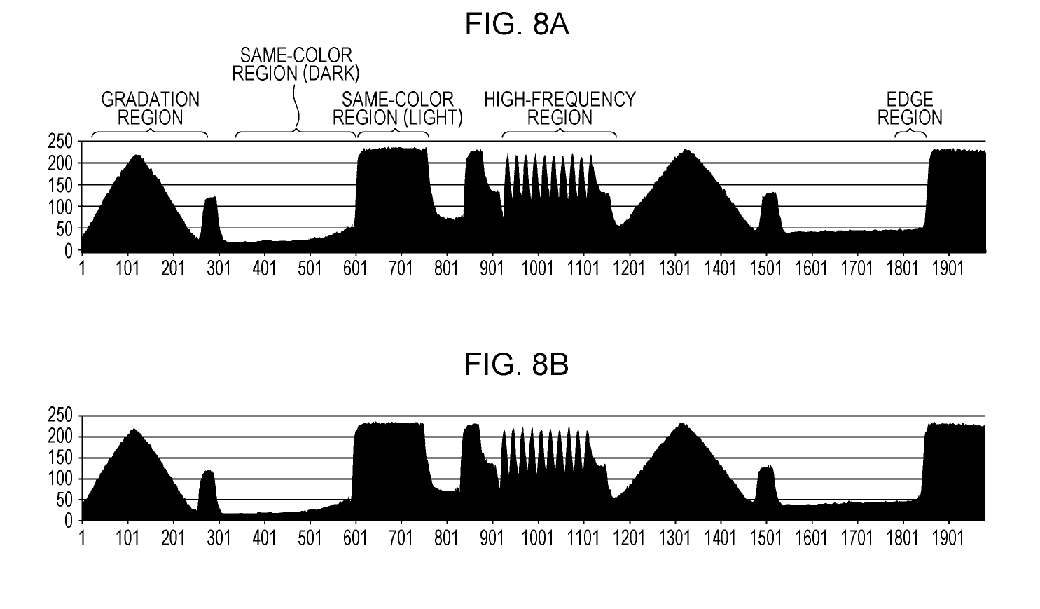

FIGS. 8A and 8B illustrate examples of the patterns of pixel values of the reference line 6 and the test line 7. FIG. 8A illustrates an example of the pattern of the pixel values of the reference line 6 (the nth line). FIG. 8B illustrates an example of the pattern of the pixel values of the test line 7 (the n+Δnth line).

In the patterns of the pixel values illustrated in FIGS. 8A and 8B, two lines are represented by pixel values using 256 grayscale levels, where “0” represents black and “255” represents white. As described above, the two lines each include the same-color region (light), the same-color region (dark), the high-frequency region, the gradation region, and the edge region. Since the test pattern is tilted at a specific angle, the pattern of the pixel values of the two lines may slightly differ from each other in the horizontal direction.

An example in which noise superimposed on the pattern of pixel values is detected will now be explained.

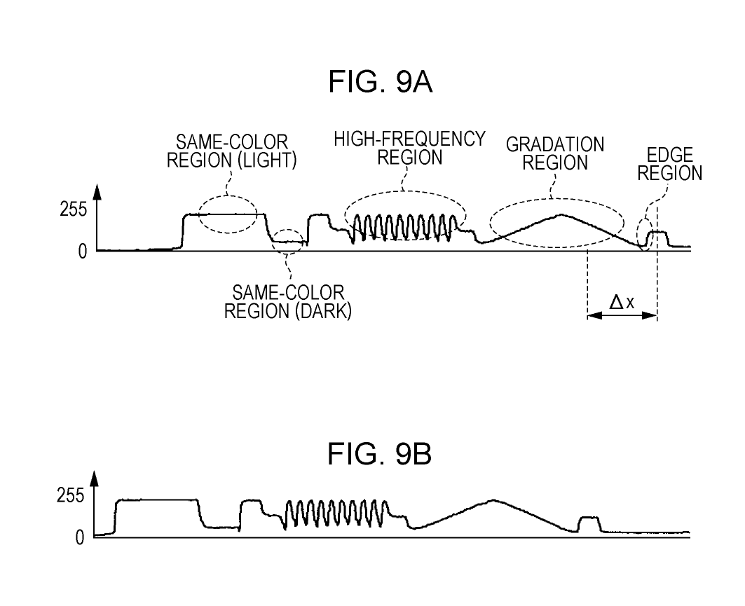

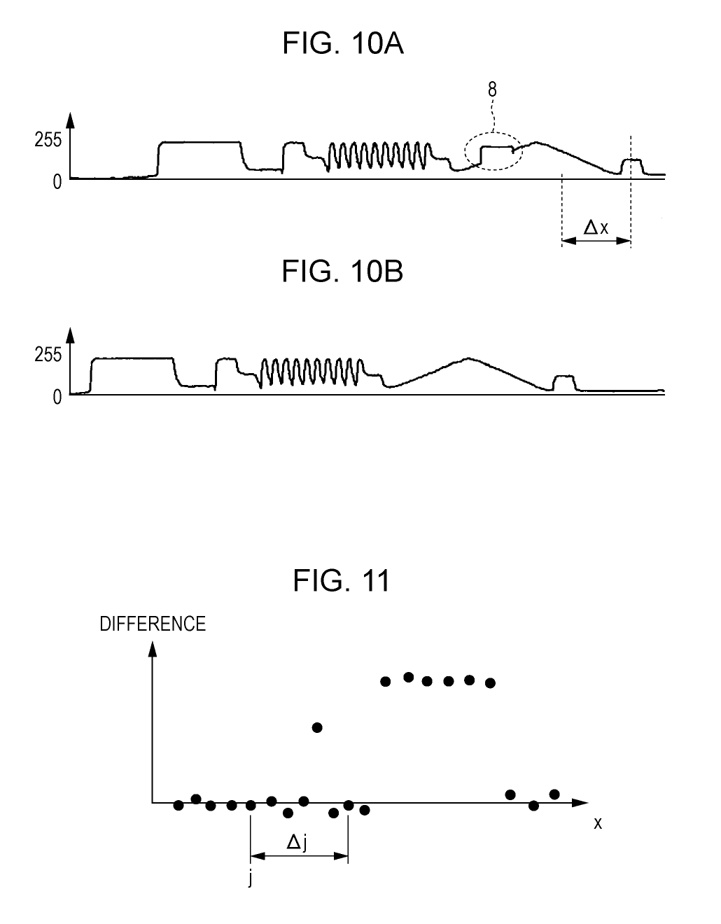

FIGS. 9A to 10B illustrate examples of the patterns of pixel values in the case where noise is superimposed on the reference line 6. FIG. 9A illustrates an example of the pattern of the pixel values of the reference line. FIG. 9B illustrates an example of the pattern of the pixel values of the test line. FIG. 10A illustrates an example of the pattern of the pixel values of the reference line. FIG. 10B illustrates an example of the pattern of the pixel values of the test line. As illustrated in FIG. 10A, block noise is generated in the gradation region of the reference line 6.

As described above, the patterns of the pixel values of the two lines differ from each other in the horizontal direction by Δx pixels even for a moving image captured for the same frame. Thus, the fitting parts 16-1 to 16-n calculate the amount Δx of shift, which is the minimum sum of squares of the difference between the patterns of the pixel values of corresponding pixels of the two lines. Since the theoretical value of the value Δx can be calculated using equation (1) provided below on the basis of the tilt θ of the pattern and the value Δn, the sums of squares for positions around the theoretical value are calculated, so that an accurate value Δx can be obtained quickly.

Δx=Δn tan θ (1)

Then, the fitting parts 16-1 to 16-n perform fitting processing for shifting the test line 7 by Δx to make the positions in the horizontal direction represented by the patterns of the pixel values of the reference line 6 and the test line 7 match one another.

FIG. 11 illustrates an example of plotted differences in the pixels values of a reference line and a test line that are made to match one another in the vertical direction.

The difference calculating parts 17-1 to 17-n perform calculation for obtaining differences in the pixel values of the pixel patterns of two lines at the positions that are made to match one another by the fitting parts 16-1 to 16-n. In the case of two lines for which noise is not detected in accordance with the result of the calculation of a difference, an ideal difference is 0. Meanwhile, when noise is detected, the difference is not 0.

The noise determining parts 18-1 to 18-n calculate local averages of differences. When an average exceeds a set threshold, it is determined that noise is generated at the corresponding position. The local average of differences is calculated using equation (2) provided below, where “j” represents the initial position at which the local average of differences is calculated, and “Δj” represents the length over which the average is taken.

$${D}_{Ave} = \frac{1}{Δ j} {\sum }_{k = j}^{j + Δ j} D ( k ) \qquad ( 2 )$$

As described above, the noise determining parts 18-1 to 18-n detect generation of noise at a specific position of a specific line. The noise position storing unit 13 collects information on the positions of noise determined by the noise determining parts 18-1 to 18-n for individual two lines of all the horizontal lines, and stores the positions of noise in the image for one frame into the memory 14.

After acquiring an image and storing the position where noise is generated, the moving image noise detecting device 1 acquires an image for the next frame from an object and performs similar processing. Then, the moving image noise detecting device 1 performs the above-described series of processing operations for all the frames in real time to achieve noise determination at high speed.

The moving image noise detecting device 1 according to this embodiment described above determines whether noise is generated by extracting the reference line 6 and the test line 7 from all the lines within one frame and performing parallel processing for the number of pairs, which corresponds to approximately half the direction of the height of an image. As described above, since the same processing can be applied to all the horizontal lines included in a moving image, the noise detecting method according to this embodiment is suitable for parallel processing. Therefore, a test can be performed thoroughly over an image, and noise detection can be performed over a moving image at high speed without any horizontal lines for which a test is not performed.

In addition, since the comparison between the pixel values of two horizontal lines included in an image is performed in real time, a memory for only one line is provided to store the reference line 6 and a memory for storing the test line 7 is not provided. Thus, the amount of memory capacity to be used can be reduced, and the cost of the memory to be implemented in the moving image noise detecting device 1 can be reduced.

In addition, since the positions of the reference line 6 and the test line 7 that are away from each other by Δn lines are made to match one another in the vertical direction and the comparison between the pixel values of the reference line 6 and the test line 7 is performed, beat noise as well as block noise can be easily detected. Since the positions of individual lines in the vertical direction can be made to match one another in units of pixels, a very small beat noise, which is difficult to be viewed by the eyes of a tester, can be detected.

In addition, the test pattern has stripes including oblique lines. Thus, even when an image of the test pattern moving in the horizontal direction is captured with a camera at a fixed position, images can be obtained as if the stripes were moved vertically above or below depending on the moving direction of the test pattern.

### 2. Modifications

When noise detecting processing is not performed in real time, the processing may be speeded up by eliminating a number of horizontal lines to be tested. Even in this case, block noise or the like superimposed on an image for a plurality of lines can be detected.

In the embodiment described above, a noise test is performed using a test pattern on which stripes including consecutive black and white lines are printed. However, the stripes may be in color. With the use of a test pattern on which stripes in color are printed, reproduction of color tone and the like can also be tested.

In addition, a similar noise test can be performed for still images as well as moving images. Thus, not only a video camera but also a still camera may be used as the test object 2. Furthermore, the number of horizontal lines to be extracted in a single processing operation is not limited to two. Noise detection may be performed using three or more extracted horizontal lines.

In addition, in the fitting processing performed by the fitting parts 16-1 to 16-n, the amount Δx of shift, which is the minimum sum of squares of the difference between the patterns of pixel values, is calculated. However, the amount Δx may be calculated in a different way. For example, the amount Δx may be calculated using the average of differences between the patterns of pixel values.

In addition, the moving image noise detecting device 1 may extract image signals for two parallel vertical lines, instead of two parallel horizontal lines. Furthermore, two lines in any direction may be extracted as long as the two lines extend in parallel.

In addition, the angle of the tilt of the test pattern relative to a horizontal line may not be set to an angle of 45 degrees. Any angle and moving direction may be set as long as the test pattern is tilted at a specific angle in a specific direction in advance and the angle and the relative moving direction of the test pattern and the camera are set in advance.

The series of processing operations according to the above-described embodiments can be executed by hardware or software. When the series of processing operations are executed by software, the series of processing operations can be executed by a computer in which a program forming the software is built in dedicated hardware or a computer to which a program for implementing various functions is installed. For example, a program forming desired software may be installed to a general-purpose personal computer or the like.

A recording medium recording a program code of the software for implementing the functions of the above-described embodiments may be supplied to a system or an apparatus. Obviously, the functions can also be implemented when a computer (or a controller such as a central processing unit (CPU)) of the system or the apparatus reads and executes the program code stored on the recording medium.

As the recording medium for supplying the program code in this case, for example, a flexible disk, a hard disk, an optical disk, a magneto-optical disk, a compact disc read-only memory (CD-ROM), a compact disc readable (CD-R), a magnetic tape, a nonvolatile memory card, or a ROM may be used.

The functions of the above-described embodiments may be implemented when the computer executes the read program code. Furthermore, an operating system (OS) or the like running on the computer executes part or all of the actual processing on the basis of instructions of the program code. The case where the functions of the above-described embodiments are implemented by the processing may also be included in the present disclosure.

It is obvious that the present disclosure is not limited to the above-described embodiments and various other applications and modifications may be made to the present disclosure without departing from the spirit of the present disclosure.

The present disclosure may employ the configurations described below.

(1) A noise detecting device including

an image acquiring unit that acquires an image from a camera that captures the image of a test pattern including a plurality of lines tilted at a specific angle relative to a specific direction, and

a parallel processing unit that sequentially extracts image signals for two lines extending in parallel in the specific direction of the image, the two parallel lines being away from each other by a specific number of lines, and that performs in a parallel manner, for each image signals for the two parallel lines, processing for detecting noise generated in the image on the basis of a difference in pixel values calculated from the image signals for the two parallel lines.

(2) The noise detecting device described in (1), wherein the parallel processing unit includes

a two-line extracting part that extracts from the image the two parallel lines, which are away from each other by the specific number of lines, as a reference line and a test line,

a fitting part that calculates the amount of shift in the specific direction of patterns of pixel values of the reference line and the test line on the basis of the specific angle of the tilted test pattern and the number of lines between the reference line and the test line,

a difference calculating part that makes the patterns of the pixel values match one another on the basis of the amount of shift to calculate the difference in the pixel values of the reference line and the test line, and

a noise determining part that determines that noise is not generated when the difference does not exceed a threshold and that noise is generated when the difference exceeds the threshold over a specific range.

(3) The noise detecting device described in (1) or (2),

wherein the test pattern and the camera are relatively moved in the specific direction, and

wherein the two line extracting part, the fitting part, the difference calculating part, and the noise determining part, each of which is arranged in a plural form in parallel, detect noise in such a manner that a pair of reference line and test line extracted by one of the two-line extracting parts is not the same as a pair of reference line and test line extracted by a different one of the two-line extracting parts.

(4) The noise detecting device described in any one of (1) to (3), wherein the test pattern and the camera are relatively moved within a certain range at a constant velocity or at a velocity variable in a sinusoidal wave manner.

(5) The noise detecting device described in any one of (1) to (4) further including a noise position storing unit that stores a detection position of noise determined by the noise determining part into a memory.

(6) The noise detecting device described in any one of (1) to (5), wherein the test pattern has periodic oblique stripes expressing characteristics of a pattern of a natural scene, the characteristics of the pattern of the natural scene including a high-frequency region, a gradation region, a light same-color region, and a dark same-color region.

(7) A noise detecting method including

acquiring an image from a camera that captures the image of a test pattern including a plurality of lines tilted at a specific angle relative to a specific direction, and

sequentially extracting image signals for two lines extending in parallel in the specific direction of the image, the two parallel lines being away from each other by a specific number of lines, and performing in a parallel manner, for each image signals for the two parallel lines, processing for detecting noise generated in the image on the basis of a difference in pixel values calculated from the image signals for the two parallel lines.

(8) A program for causing a computer to execute processing including

acquiring an image from a camera that captures the image of a test pattern including a plurality of lines tilted at a specific angle relative to a specific direction, and

sequentially extracting image signals for two lines extending in parallel in the specific direction of the image, the two parallel lines being away from each other by a specific number of lines, and performing in a parallel manner, for each image signals for the two parallel lines, processing for detecting noise generated in the image on the basis of a difference in pixel values calculated from the image signals for the two parallel lines.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A noise detecting device comprising:
an image acquiring unit that acquires an image from a camera that captures the image of a test pattern including a plurality of lines tilted at a specific angle relative to a specific direction; and
a parallel processing unit that sequentially extracts image signals for two lines extending in parallel in the specific direction of the image, the two parallel lines being away from each other by a specific number of lines, and that performs in a parallel manner, for each image signals for the two parallel lines, processing for detecting noise generated in the image on the basis of a difference in pixel values calculated from the image signals for the two parallel lines.

2. The noise detecting device according to claim 1, wherein the parallel processing unit includes:
a two-line extracting part that extracts from the image the two parallel lines, which are away from each other by the specific number of lines, as a reference line and a test line;
a fitting part that calculates the amount of shift in the specific direction of patterns of pixel values of the reference line and the test line on the basis of the specific angle of the tilted test pattern and the number of lines between the reference line and the test line;
a difference calculating part that makes the patterns of the pixel values match one another on the basis of the amount of shift to calculate the difference in the pixel values of the reference line and the test line; and
a noise determining part that determines that noise is not generated when the difference does not exceed a threshold and that noise is generated when the difference exceeds the threshold over a specific range.

3. The noise detecting device according to claim 2,
wherein the test pattern and the camera are relatively moved in the specific direction, and
wherein the two-line extracting part, the fitting part, the difference calculating part, and the noise determining part, each of which is arranged in a plural form in parallel, detect noise in such a manner that a pair of reference line and test line extracted by one of the two-line extracting parts is not the same as a pair of reference line and test line extracted by a different one of the two-line extracting parts.

4. The noise detecting device according to claim 3, wherein the test pattern and the camera are relatively moved within a certain range at a constant velocity or at a velocity variable in a sinusoidal wave manner.

5. The noise detecting device according to claim 4, further comprising a noise position storing unit that stores a detection position of noise determined by the noise determining part into a memory.

6. The noise detecting device according to claim 5, wherein the test pattern has periodic oblique stripes expressing characteristics of a pattern of a natural scene, the characteristics of the pattern of the natural scene including a high-frequency region, a gradation region, a light same-color region, and a dark same-color region.

7. A noise detecting method comprising:
acquiring an image from a camera that captures the image of a test pattern including a plurality of lines tilted at a specific angle relative to a specific direction; and
sequentially extracting image signals for two lines extending in parallel in the specific direction of the image, the two parallel lines being away from each other by a specific number of lines, and performing in a parallel manner, for each image signals for the two parallel lines, processing for detecting noise generated in the image on the basis of a difference in pixel values calculated from the image signals for the two parallel lines.

8. A program for causing a computer to execute processing comprising:
acquiring an image from a camera that captures the image of a test pattern including a plurality of lines tilted at a specific angle relative to a specific direction; and
sequentially extracting image signals for two lines extending in parallel in the specific direction of the image, the two parallel lines being away from each other by a specific number of lines, and performing in a parallel manner, for each image signals for the two parallel lines, processing for detecting noise generated in the image on the basis of a difference in pixel values calculated from the image signals for the two parallel lines.
